(19) United States
(12) Patent Application Publication
(10) Pub. No.: US 2008/0156719 A1
(43) Pub. Date: Jul. 3, 2008

(54) Automated self cleaning filter

(75) Inventor: Philip Ignatius Tabor, Davie, FL (US)

Correspondence Address: Philip Tabor, 13530 SW 6 Place, Davie, FL, 33325, US

(73) Assignee: Philip Ignatius Tabor, Davie, FL (US)

(21) Appl. No.: 11/982,982

(22) Filed: Nov. 6, 2007

Related U.S. Application Data
(60) Provisional application No. 60/858,550, filed on Nov. 13, 2006.

(51) Int. Cl. B01D 35/16

(52) U.S. Cl. 210/409

(57) ABSTRACT

An automated self-cleaning filter device consisting of a controller that operates with a circuit board, microprocessor and electronic components that manipulate valves and pump(s). The aforementioned controller selects the proper position, i.e., open, closed for valves and i.e., on or off, for pump or pumps; the controller also commands and controls the periods of time necessary to achieve proper cleaning of the filter element. The device contains a hollow manifold that can be dimensioned to receive cylindrical, square or rectangular filter element within the central opening. The aforementioned manifold resides inside a sealed housing and supplies liquid to a plurality of nozzles directing pressurized fluid in streams, which face the outer surface of the filter element.

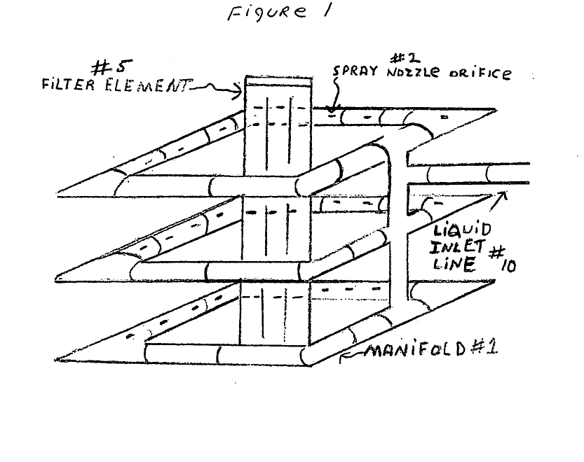

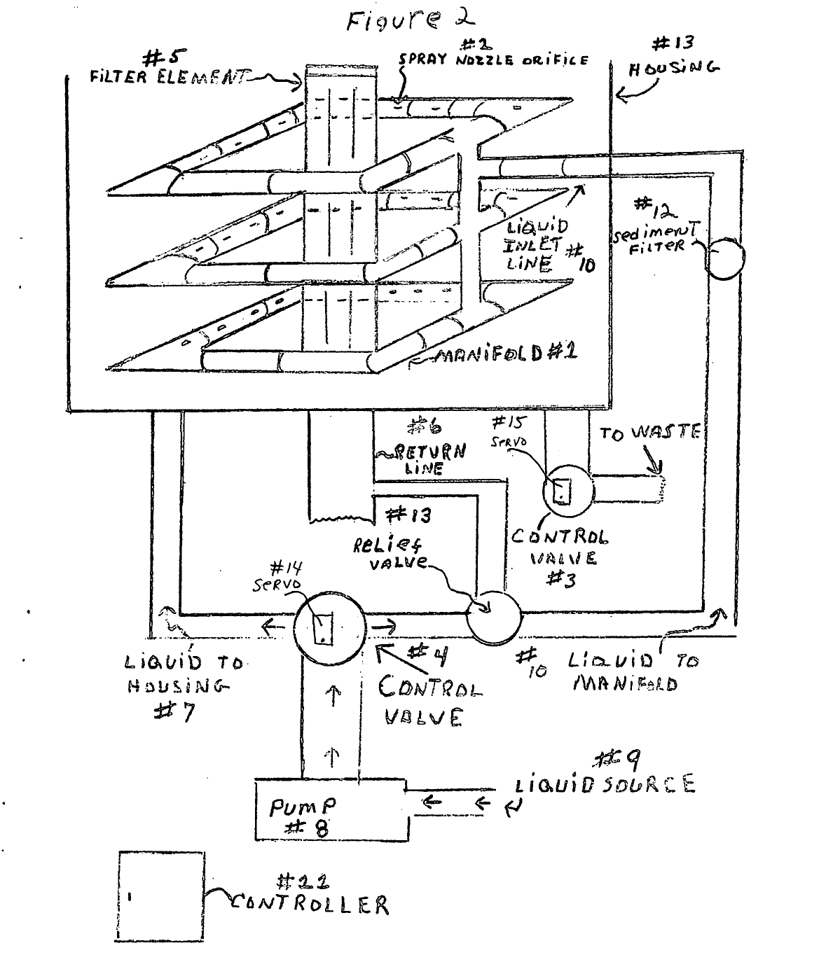

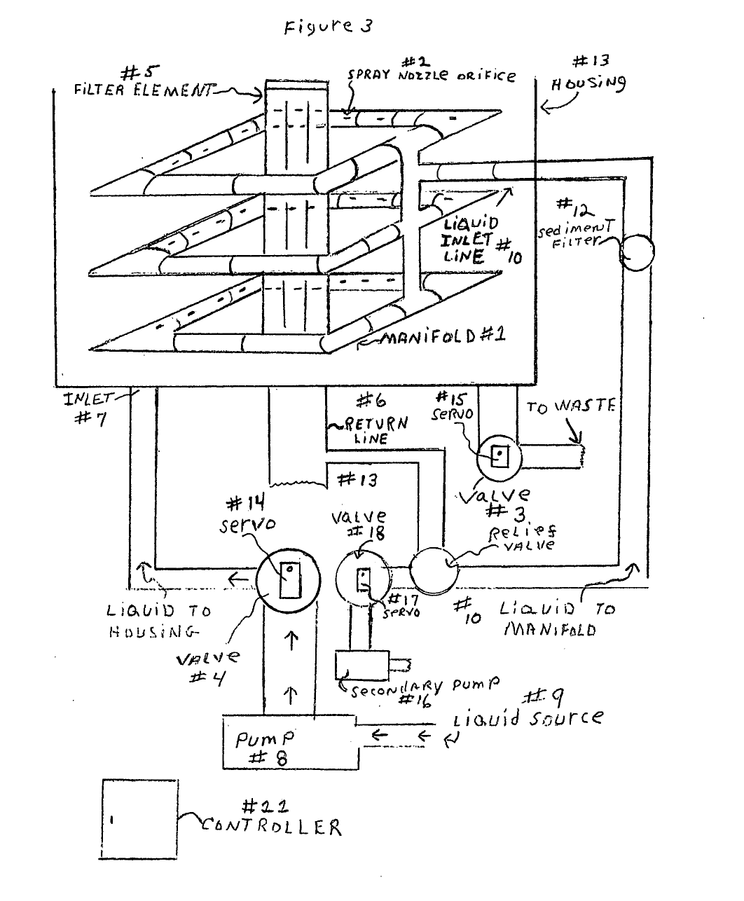

I am claiming the benefit of a prior filed copending nonprovisional application number 60/858550 filed on Nov. 13, 2006.

When a cleaning cycle occurs, the controller FIG. #11 sends a signal to a servo FIG. #14. The servo opens valve FIG. #4, which directs the liquid into the manifold FIG. #1. Liquid FIG. #9 is supplied to the manifold FIG. #11 after passing through a sediment filter FIG. #12 by means of a pump FIG. #8.

The manifold FIG. #1 and the filter element FIG. #5 are contained in a housing FIG. #13. The controller FIG. #11 also controls the off on function of the pump FIG. #8 and also sends signals to servo FIG. #15 that opens and closes valve FIG. #3 which directs liquid to waste. The liquid is directed through piping FIG. #10 into the manifold FIG. #1. The liquid that was being directed to the inside of the housing #13 through the housing inlet #7, and passing through the filter element FIG. #5 has been terminated by means of valve FIG. #4. The manifold #1 is hollow and has an upper, middle and lower section. The pressurized liquid is directed out of the spray nozzles FIG. #2 that directs liquid inwardly cleaning the filter element. The soiled liquid is drained by means of gravity, out of the tank through a valve FIG. #3

It is to be understood that the phraseology or terminology used herein is for the purpose of description and not limitation.

It is to be understood that the invention is not limited in is its application to the details of construction and arrangements of parts illustrated in the accompanying drawings since the invention is capable of other embodiments and of being practiced or carried out in various ways.

The invention described in this specification is an automatic self-cleaning filtering device comprising: A controller #11 that has a circuit board, microprocessor and necessary electronics, said controller #11 provides all of the input and output connections necessary to communicate with and provide power to the various components of the machine, it controls the components, that manipulates valves and pump(s) as to what position they should be in, at what time, and also controls the time of cleaning cycles, whereby this device can run unattended and automatically;

Unlike the inventions fashioned by Lang and Carnot, June 1974, U.S. Pat. No. 3,820,552 and Trotter, April 1985, U.S. Pat. No. 4,509,545 Lang, Carnot, and Trotter's devices are portable washing devices.

Their devices require that the filter housing must be disassembled and the filter element be removed from its housing, The filter element must then be placed into their device, a water hose must be connected to their device, whereby you are restricted by whatever water pressure may or may not be present.

After the cleaning process with these portable devices you must the remove filter element from their device and reinstall the filter element back into its housing, and reassemble filter housing making this a very labor intensive job which is not truly self cleaning or automatic.

The Automated self cleaning filter includes a housing #13 which surrounds and seals the filter element #5 and manifold #1, said housing has an inlet #7 whereby liquid enters the tank through a formed port in the filter housing, liquid that enters the tank housing passes through a filter element #5, said housing has a formed outlet that the return line connects to #6 on the bottom of the tank aligning to the center of the filter element #5; said housing #13 has a opening to waste which is formed on the bottom of the filter housing, which is opened and closed by a valve #3 that is manipulated by a servo #15 which is controlled a controller #11; a manifold #1 contained inside the said housing #13 that is hollow and supplies liquid to a plurality of nozzles #2 for directing pressurized fluid in streams which face the outer surface of the filter element: the said manifold #1 surrounds the filter element #5 and has a upper, middle and lower section, which are obvious in the drawings, middle sections will vary in number according the height of the filter element; an inlet to the said manifold which is opened and closed by a valve #4 or #18, depending on what system design is being used, the valves are manipulated by a servo #14 or 18, which are controlled by said controller #11;

Liquid supplied to the manifold #1 can be the liquid present in the system, such as in the case of maintained swimming pool water, or connected to an external pump #16 that has a outside source of liquid and that pump also being controlled by the said controller #11. When a cleaning cycle occurs, the controller #11 turns off the pump #8.

The controller #11 manipulates servo #15 installed on valve #3 opening it.

The opening of valve #3 directs the liquid that is in the filter tank to waste by means of gravity.

The controller #11 manipulates a servo #14 that is installed on a 3-way valve #4, this valve directs liquid to either the filter housing port #7 or to the manifold #1.

During a cleaning cycle this 3-way valve #4 is positioned so that the liquid that was being directed into the filter housing is directed through a check relief valve #13 with a set pressure which is included between the 3-way valve #4 and the sediment filter #12 on the inlet supply line for the manifold #1, its purpose is for consistent proper pressure and safety. The excess pressurized liquid is directed to the return line #6. The residual pressurized liquid then passes through a sediment filter #12 mounted after the check relief valve #13 on the supply line to the said manifold #1 before the inlet on the outside of the filter housing #13, its purpose is to reduce the possibility of the nozzles orifices #2 from being clogged. The liquid then enters the manifold #1;

The pressurized liquid is supplied to a plurality of nozzles directing fluid in streams, which face the outer surface of the filter element #5; liquid flushes off the accumulated dirt and debris cleaning the filter element. When the cleaning mode is complete, the controller #11 shuts off pump #8. Valve #4, is a 3-way valve positioned by a servo #14, the servo is controlled by the controller #11.

Valve #4 is positioned so that the liquid is directed back into the filter housing #13 and the port that supplies liquid to the manifold #1 is closed. The controller #11 manipulates the servo #15 installed on valve #3 closing valve #3 which allowed the waste to drain.

The controller #11 turns on the pump #8 which pumps fluid into the inlet #7 filling the filter housing with liquid, and that liquid passes through the filter element and exits into the return line #6.

In a designed system with a external source of liquid supply, a secondary pump #16 receives it's liquid supply for cleaning the filter element from an outside source, the secondary pump is connected to the pluming system of the automated self-cleaning filter.

When a cleaning cycle occurs, the controller #11 shuts off pump #8, the controller #11, manipulates servo #15 installed on valve #3 opening valve #3 the result being, the liquid that is in the filter tank is directed to waste by means of gravity, controller #11 manipulates servo #14 installed on valve #4, a two way valve is used instead of a three way valve in this process, positioning valve #4 so that it is closed from the liquid that is to be filtered.

Controller #11 manipulates the servo #17 installed on valve #18 to the open position, this valve opens the entrance of liquid to the manifold from the secondary pump, controller #11 then turns on the secondary pump #16. The external liquid, such as fresh water, then passes through a check relief valve #13 with a set pressure, which is included between valve #18 and the sediment filter #12 on the inlet supply line for the manifold #1, its purpose is for consistent proper pressure and safety. The excess pressurized liquid is directed to the return line #6. The residual pressurized liquid then passes through a sediment filter #12 mounted after the check relief valve #13 on the supply line to the said manifold #1 before the inlet on the outside of the filter housing #13, its purpose is to reduce the possibility of the nozzles orifices #2 from being clogged.

The liquid then enters the manifold #1; the pressurized liquid is supplied to a plurality of nozzles directing fluid in streams, which face the outer surface of the filter element #5, liquid flushes off the accumulated dirt and debris cleaning the filter element.

When the cleaning cycle finishes the controller #11 turns off the secondary pump #16 and manipulates the servo #17 closing valve #18, which supplied the external liquid to the manifold.

Controller #11 manipulates servo #14 opening valve #4, allowing liquid to be filtered into the filter housing through the inlet #7.

The controller #11 manipulates the servo #15 installed on valve #3 closing valve #3 which allowed the waste to drain. The Controller #11 then turns on pump #8, which pumps fluid into the inlet #7 filling the filter housing with liquid, that liquid passing through the filter element and exits into the return line #6.

### References Cited

### U.S. Patent Documents

U.S. Pat. No, 3,820,552. June 1974 Lang and Carnot

You need to dissemble filter housing, connect device to water hose and place over filter element.

U.S. Pat. No. 4,509,545 April 1985 Trotters

Is a portable washing device and must is connected to a water hose. The filter housing must be disassembled and the filter element removed from its housing, placed into the device, a water hose must be connected to the device, making this a low pressure system, after the cleaning process you must remove filter element from his device and reinstall into filter element back into its housing, and reassemble filter housing making this a very labor intensive job.

1. A device that automates and controls the process of cleaning cartridge type filters commonly found in recreational water use such as swimming pools, spas, water-parks, fountains, wading ponds kiddy pools and fish ponds said device contains a controller that has a circuit board, microprocessor and necessary electronics, said controller provides all of the input and output connections necessary to communicate with and provide power to the various components of the machine, it controls the components, that manipulates valves and pump(s) as to what position they should be in, at what time, and also controls the time of cleaning cycles, whereby this device can run unattended and automatically;

2. A device, that contains inside a sealed housing, a hollow manifold comprising three main sections surrounding the filter element consisting of upper, middle and lower sections, that can vary in overall height by expanding the middle section; transporting liquid under pressure to multiple spray nozzles facing the outer surface of the filter element resulting in removing dirt and debris and various other contaminants,
said device using the formidable high pressure spray created by a pump to the nozzles which deliver more pounds of pressure per square inch of liquid used for removal of dirt, debris and other contaminants, than the current methodology in common use, being a rubber hose attached to common faucet.

3. A device that delivers the cleaning process in a self contained environment that eliminates the requirement of removal of the cartridge filter element from its housing to affect cleaning by whatever method said device provides the automatic removal of the soiled liquid consisting of dirt, debris and other contaminants removed from the cartridge filter element from said device by use of an automated valve providing permanent exit of the soiled liquid.
